(19) United States
(12) Patent Application Publication
(10) Pub. No.: US 2013/0117476 A1
(43) Pub. Date: May 9, 2013

(54) LOW-POWER HIGH-SPEED DATA BUFFER

(71) Applicants: William V. Miller, Austin, TX (US); Robert D. Kenney, Austin, TX (US); Charles E. Pope, Austin, TX (US)

(72) Inventors: William V. Miller, Austin, TX (US); Robert D. Kenney, Austin, TX (US); Charles E. Pope, Austin, TX (US)

(21) Appl. No.: 13/291,703

(22) Filed: Nov. 8, 2011

(51) Int. Cl. G06F 3/00

(52) U.S. Cl. 710/52

(57) ABSTRACT

Techniques are disclosed relating to buffer circuits. In one embodiment, a buffer circuit is disclosed that includes memory unit and an output register. The memory unit is configured to store a plurality of buffer entries and a first pointer to a current one of the plurality of buffer entries. The output register is coupled to an output of the memory unit. The buffer circuit is configured to perform a read operation by outputting a current value of the output register and storing a value of the current buffer entry in the output register. The buffer circuit is configured to update the first pointer in response to the read operation.

### BACKGROUND

1. Technical Field

This disclosure relates generally to integrated circuits, and, more specifically, to data buffers within integrated circuits.

2. Description of the Related Art

Data buffers may be used in a variety of applications in which it is desirable to temporarily store information. Some buffers may be configured to store data and output it in the same order as it is received (referred to as a first-in-first-out (FIFO) buffer). Alternatively, some data buffers may be configured to store data and output it in an order in which the most recently received data is output first (referred to as a last-in-first-out (LIFO) buffer). Other forms of buffers may include round-robin buffers, priority buffers, etc.

In some instances, a data buffer, such as a FIFO buffer, may be implemented as a shift-register buffer in which data is stored within a set of registers that are chained together in a series. When data is read from the buffer, the contents of each register is shifted into the next respective register, and the contents of the last register are shifted out of the buffer as the output. Shift-register buffers typically have smaller clock-to-q times (i.e., the interval between when a driving signal (e.g., clock signal) is provided and the output (referred to as “q”) becomes available); however, such buffers may also have greater power consumptions as each read may require latching multiple registers.

In other instances, a data buffer may be implemented as a read-/write-pointer buffer in which data is stored in a single location as it passes through the buffer (as opposed to shifting through multiple locations), where the ordering for writes and reads are dictated by maintained pointers. Such registers may be more power efficient since multiple registers do not need to be latched during a read, but these buffers often have higher clock-to-q times because of the usage of pointers.

### SUMMARY OF EMBODIMENTS

The present disclosure describes embodiments of a buffer circuit that includes a memory unit and an output register. In one embodiment, the output register is configured to store an initial buffer entry (i.e., the first entry stored in the buffer circuit after being empty), and the memory unit is configured to store subsequent buffer entries. In some embodiments, the memory unit includes a plurality of registers to store buffer entries. In some embodiments, the memory unit includes a memory array to store buffer entries.

In one embodiment, the buffer circuit is configured to implement a FIFO buffer. When a write operation is performed for an initial entry, the buffer may store it in the output register (which, in some embodiments, is a single register for storing one entry). If a subsequent a read operation is requested, this entry is shifted out as the output of the buffer. When multiple write operations are performed, subsequent entries may be stored in the memory unit. If a read operation is then requested, the entry in the register may be shifted out and a new entry may be latched in from the memory unit.

In many instances, the buffer circuit may have the faster access times afforded by shift-register buffers while also having the greater power savings afforded by read-/write-pointer buffers.

### BRIEF DESCRIPTION OF THE DRAWINGS

FIG. 1 is a block diagram of one embodiment of a data buffer.

FIG. 2 is a block diagram of one embodiment of a memory unit within the data buffer.

FIGS. 3A and 3B are block diagrams of other embodiments of a memory unit within the data buffer.

FIG. 4 is a flow diagram illustrating one embodiment of a method performed by the data buffer.

FIGS. 5A-5D are block diagrams illustrating exemplary write and read operations.

FIG. 6 is a block diagram illustrating one embodiment of an exemplary computer system.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

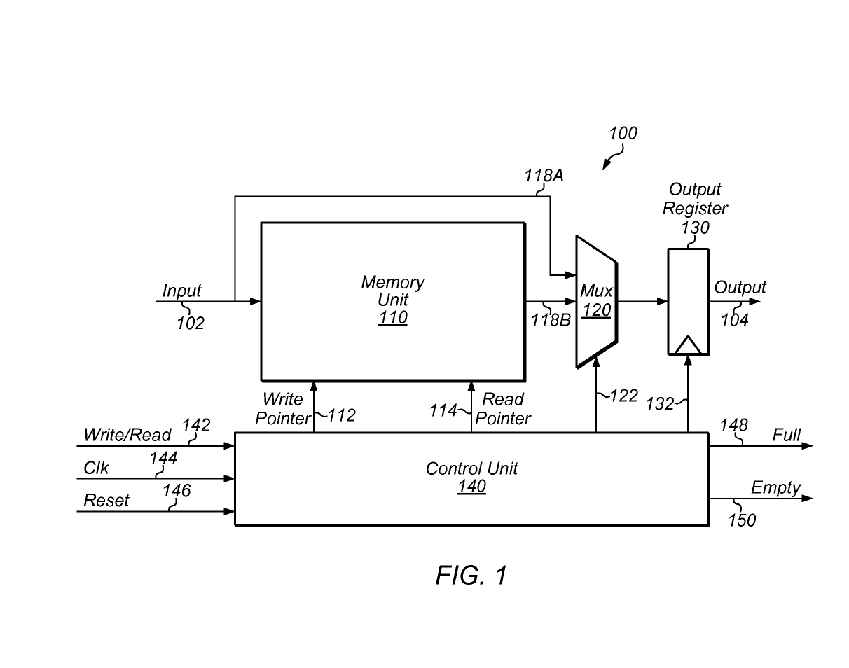

Turning now to FIG. 1, a block diagram of a data buffer 100 is depicted. Data buffer 100 is one embodiment of a buffer circuit that may be used in a variety of applications in which information is temporarily stored and then accessed in a particular ordering. For example, data buffer 100 may be used to facilitate the exchange of information between circuits that process information asynchronously such as for circuits that operate in different clock domains. Data buffer 100 may also be used to pass information from a producing circuit to multiple consuming circuits or from multiple producing circuits to a consuming circuit. In some embodiments, data buffer 100 may be included within integrated circuits of computer systems such as within processors, bridge devices, peripheral devices, memory, network devices, etc.

In the illustrated embodiment, data buffer 100 is configured to implement a FIFO buffer in which values are output (at output 104) in the same order as they are received (at input 102). As shown, data buffer 100 includes a memory unit 110, multiplexer (MUX) 120, output register 130, and control unit 140. As will be described below, in various embodiments, data buffer 100 is configured to store an initial buffer entry in register 130 and subsequent buffer entries in memory unit 110 as data buffer 100 fills with the performance of multiple write operations. (As used herein, the term “buffer entry” refers to a received value that has been stored in (i.e., written to) a data buffer.) When a read operation is subsequently performed, if data buffer 100 includes only one entry, the value of that entry is output from register 130, and, in one embodiment, the value stored in register 130 remains the same. If, however, data buffer 100 includes multiple entries, the entry stored in register 130 is provided as the output of the read operation, and the next entry (i.e., the entry to be output during the next read operation) is read from memory unit 110 and stored in register 130.

Data buffer 100 may also be configured to implement types of buffers other than FIFO buffers in other embodiments. Accordingly, in one embodiment, data buffer 100 is configured to implement a LIFO buffer. In such an embodiment, data buffer 100 may write an initial entry to register 130. As subsequent write operations are performed, data buffer 100 may write those values to register 130 after sending the current entry stored in register 130 to memory unit 110. When a subsequent read operation is performed, data buffer 100 may provide the entry in register 130 as the output and read the next entry from memory unit 110 into register 130. In another embodiment, data buffer 100 may be configured to implement a round-robin buffer. For example, data buffer 100 may include multiple instances of memory unit 110 and register 130, and may be configured to select between the outputs of the registers 130 in a round-robin manner. In other embodiments, data buffer 100 may be configured to implement a priority buffer in which particular values are assigned a respective priority and output based on those priorities. In short, various techniques described herein are not applicable to only FIFO buffers.

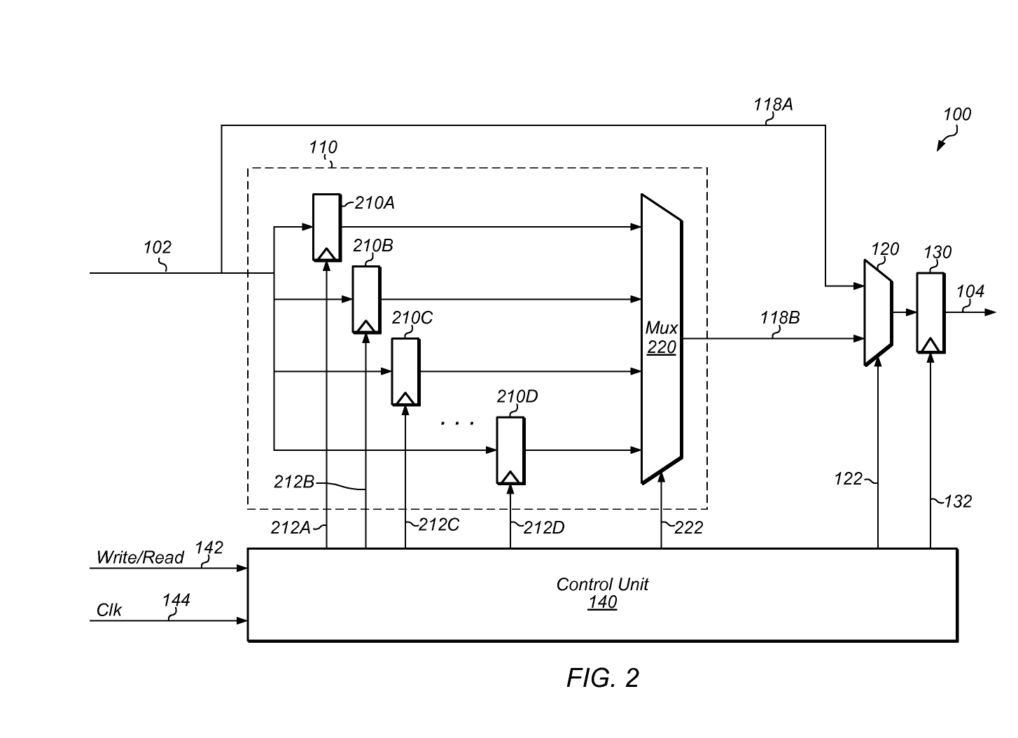

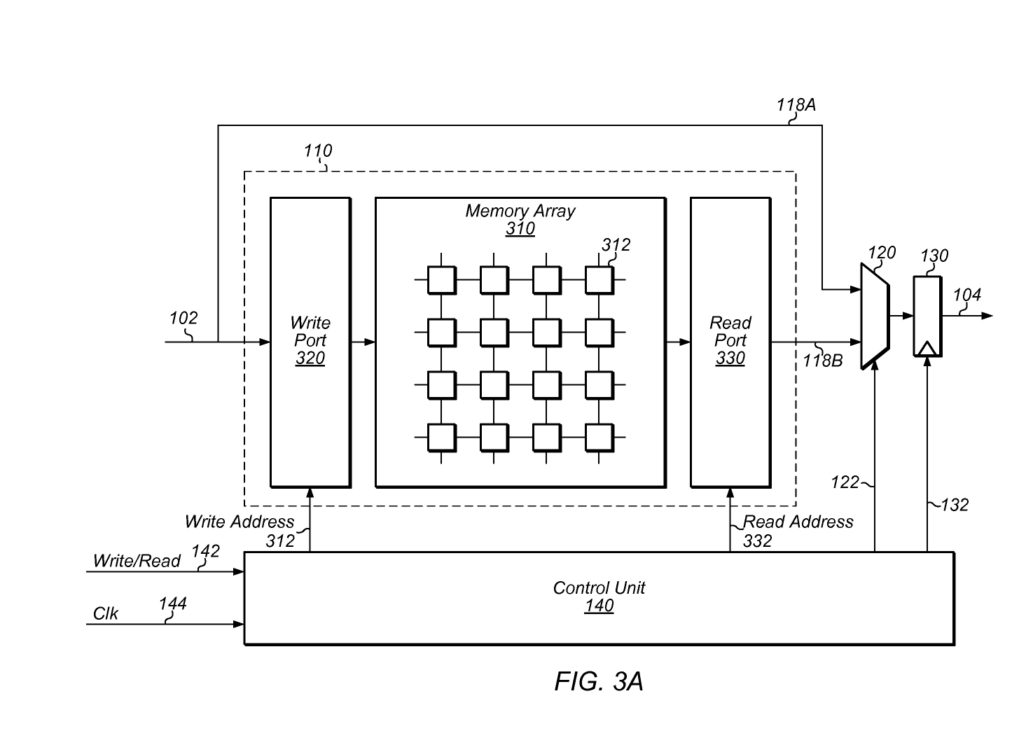

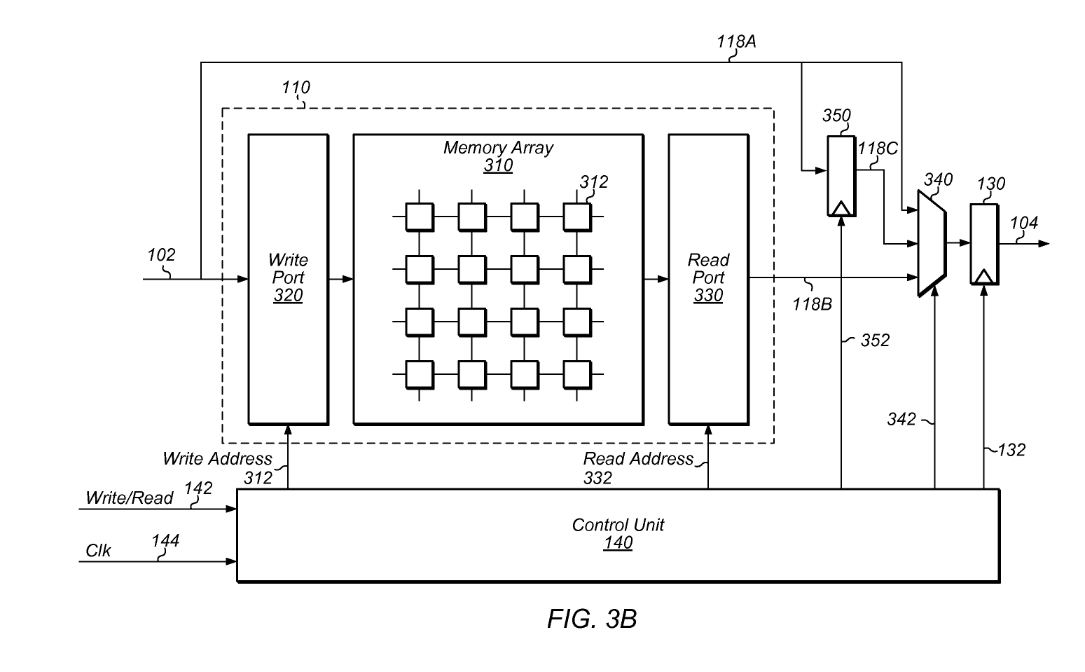

As discussed above, memory unit 110, in one embodiment, is configured to store buffer entries after an initial entry has been stored in register 130. (In some embodiments, data buffer 100 may include multiple instances of register 130 chained to together in a shift-register manner; in which case, registers 130 may store more than just one entry for buffer 100.) As entries are then read from data buffer 100, in one embodiment, memory unit 110 is further configured to provide stored entries to register 130 for output in subsequent read operations. In some embodiments, memory unit 110 may store entries in multiplier registers such as described below in conjunction with FIG. 2. In some embodiments, memory unit 110 may store entries in a memory array such as described in conjunction with FIG. 3.

In various embodiments, a write pointer 112 and a read pointer 114 are used to track which memory locations within unit 110 are available to store entries and which memory locations are already storing entries. In the illustrated embodiment, control unit 140 (described below) is configured to store and maintain pointers 112 and 114; however, in other embodiments, other units such as memory unit 110 may store and/or maintain pointers 112 and 114. In one embodiment, write pointer 112 may identify the next available location for storing a value (in another embodiment, write pointer 112 may identify the location of the last-written entry). Similarly, read pointer 114 may identify the location of the next entry to be shifted into register 130, in one embodiment (or may identify the location of the most of the last-shifted entry, in another embodiment). In some embodiments, pointers 112 and 114 may be advanced (i.e., updated) in a single direction (i.e., only incremented or only decremented). Accordingly, when memory unit 110 is empty, pointers 112 and 114 may point to the same location (or adjacent locations in another embodiment). As entries are stored and retrieved, pointers 112 and 114 respectively separate and come together. Eventually, pointers 112 and 114 are advanced until they reach a last location (e.g., corresponding to a highest memory address or to a last register); at which point, the pointers 112 and 114 are reset back to an initial location (e.g., corresponding to an initial memory address or to an initial register). Because pointers 112 and 114 eventually point to locations that were previously pointed to, the manner in which the pointers are advanced may be described as being “circular.” Memory unit 110 may therefore be described, in some embodiments, as being a “circular buffer circuit.”

Output register 130, in one embodiment, is configured to store the next entry that is to be output by data buffer 100 during the next read operation. In some embodiments, register 130 may include multiple latches (i.e., flip-flops) configured to store bits of data such as set-reset (SR) latches, gated D latches, etc. As discussed above, register 130 may store the initial entry written after data buffer 100 is empty. In the illustrated embodiment, register 130 receives the value for this initial entry from input 102 via path 118A, which bypasses memory unit 110 (said another way, path 118A does not include memory unit 110; thus memory unit 110 does not store the value of this entry). Output register 130 may then store subsequent entries received from memory unit 110 via path 118B during performance of read operations. In the illustrated embodiment, multiplexer 120 is configured to select between paths 118A and 118B based on a selection signal 122 provided by control unit 140. In the illustrated embodiment, register 130 is also configured to latch a received value (i.e., capture the value) based on a latch signal 132 provided by control unit 140.

Control unit 140, in one embodiment, is configured to control operation of buffer 100. (Although shown as a contiguous block in the illustrated embodiment, control unit 140, in some embodiments, may be several separate units. Such units may be located within other ones of units 110-130.) As will be described below, in various embodiments, control unit 140 is configured to coordinate performance of write and read operations in response to respective write and read requests (e.g., as indicated by write/read signals 142). To facilitate performance of the operations, control unit 140 may control memory unit 110, multiplexer 120, and register 130 based on pointers 112 and 144, selection signal 122, and latch signal 132. In one embodiment, control unit 140 may coordinate the timing of various signals based on a clock signal (Clk) 144. In some embodiments, control unit 140 is further configured to provide an indication 148 specifying when data buffer 100 is full and an indication 150 specifying when data buffer 100 is empty (in one embodiment, if data buffer 100 is empty, data buffer 100 may also be configured to continue to provide the last valid value read from output 104). In the illustrated embodiment, control unit 140 is also configured to reset data buffer 100 in response to a reset signal 146. In one embodiment, control unit 140 may reset buffer 100, by setting pointers 112 and 114 to a default value and clearing a valid flag for register 130. In some embodiments, control unit 140 may further overwrite the contents of memory unit 110 and register 130 with a default value.

In many instances, data buffer 100's usage of output register 130 allows it to have faster access times during read operation while buffer 100's usage of memory unit 110 also allows it to be more power efficient. Thus, in some embodiments, data buffer 100 is able to provide benefits of both shift-register buffers and write-/read-pointer buffers.

Turning now to FIG. 2, one embodiment of memory unit 110 within data buffer 100 is depicted. In the illustrated embodiment, memory unit 110 includes multiple register 210A-D and a multiplexer 220. In some embodiments, memory unit 110 may include more or less registers 210 than shown.

As discussed above, in various embodiments, memory unit 110 is configured to begin storing buffer entries after buffer 100 includes at least one entry (which is stored in register 130). In one embodiment, memory unit 110 stores each entry in a respective one of registers 210. In the illustrated embodiment, control unit 140 is configured to facilitate performance of a write operation to one of registers 210, by providing a respective one of latch signals 212A-D. In various embodiments, control unit 140 may coordinate when the latch signal 212 is provided based on clock signal 144 (in one embodiment, control unit 140 may be configured to actually provide signal 144 as the signal 212 to a given register 210). In various embodiments, control unit 140 is also configured to select which register 210 is to be latched based on a maintained write pointer such as write pointer 112. For example, in one embodiment, if memory unit 110 is empty, pointer 112 may identify register 210A as being available. When control unit 140 receives a write signal 142, control unit 140 may then drive latch signal 212A to cause register 210A to latch the value at input 102. Control unit 140 may then update pointer 112 to point to register 210B. As additional entries are stored, control unit 140 may continue to update pointer 112 and provide corresponding signals 212. In one embodiment, if memory unit 110 is implementing a circular buffer and pointer 112 is pointing to the last register (e.g., register 212D), control unit 140 may update pointer 112 to point back to an initially used register (e.g., register 210A) if it is available for storage.

As discussed above, in various embodiments, memory unit 110 is configured to provide a value of an entry to register 130 when the entry in register 130 is output during a read operation. In the illustrated embodiment, control unit 140 is configured to facilitate performance of a read operation by providing a selection signal 222 to multiplexer 220 to cause it to select an output of one of registers 210. Control unit 140 may also provide signal 122 to cause multiplexer 120 to select multiplexer 220 as an input, and may provide signal 132 to cause register 130 to latch the incoming value of the next entry. As noted above, control unit 140 may coordinate the timing of these signals with clock signal 144. In various embodiments, control unit 140 may also be configured to select the register 210 storing the next entry for register 130 based on a read pointer such as pointer 114, which is updated in a similar manner as the write pointer. For example, if pointer 114 currently points to register 210A as storing the next entry for register 130 and register 210B stores the following entry, control unit 140 may update the read pointer to point to register 210B in response to the read operation that causes the value to be shifted output of register 210A into register 130.

In some embodiments, control unit 140 is also configured to perform read and write operations within the same memory access cycle (e.g., within one cycle of clock signal 144). In one embodiment, if buffer 100 includes only one entry, the value of the entry may be read from output 104 during the clock period while the value being written may bypass memory unit 110 and be clocked into register 130 (e.g., upon the next rising edge of Clk 144). If buffer 100 includes more than one entry, then the value of the first entry may be read from output 104 during the clock period, while the next entry is provided from memory unit 110 to be clocked into register upon the next rising edge, and while the value to be written is clocked into the appropriate register 210A-210D.

Turning now to FIG. 3A, another embodiment of memory unit 110 is depicted. In the illustrated embodiment, memory unit 110 includes a memory array 310 that, in turn, includes multiple memory cells 312. The memory array 310 is coupled to a write port 320 and a read port 330.

In the illustrated embodiment, memory unit 110 is configured to store entries within memory cells 312 of memory array 310. In some embodiments, memory cells 312 may occupy less die space than registers 210 (particularly when data buffer 100 has several locations for entries); however, memory cells 312 may have longer clock-to-q times than registers 210.

In one embodiment, control unit 140 is configured to facilitate performance of a write operation to one or more memory cells 312, by providing a write address 312 to write port 320. In one embodiment, write port 320 is configured to receive the value from input 102 and activate the appropriate rows and columns of cells 312 within memory array 310 to store the entry at the specified address 312. In some embodiments, control unit 140 may maintain write address 312 as a write pointer 112. Accordingly, as values are stored into memory array 310, control unit 140 may update the write address 312 so that it is usable to identify available memory locations for subsequent write operations. In one embodiment, control unit 140 may be configured to update write address 312 in a circular manner such as described above. As discussed above, control unit 140 may coordinate the timing of various signals based on clock signal 144.

In one embodiment, control unit 140 is configured to facilitate performance of a read operation from one or more memory cells 312, by providing a read address 332 to read port 330. In one embodiment, read port 330 is configured to activate the appropriate rows and columns of cells 312 and read the entry at the specified address 332. In some embodiments, control unit 140 may be configured to maintain read address 332 as a read pointer 114 in similar manner as described above for write address 312.

In some embodiments, control unit 140 may be configured to facilitate performance of simultaneous write and read operations as described above in conjunction with FIG. 2. In some embodiments, however, memory array 310 may not be capable of writing and reading the same location in the same clock period. In such cases, one or more additional registers may be included within buffer 100 such as shown in FIG. 3B. In the illustrated embodiment of FIG. 3B, buffer 100 includes a new 3-input multiplexer 340 (which receives a selection signal 342) and an additional register 350 (which receives a latch signal 352). In such an embodiment, register 350 is configured to store the second entry for buffer 100, and memory array 310 is configured to store the third and greater entries. In one embodiment, register 350 may be configured to provide the value of entries within one clock period of being written, while memory array 310 may take one or more additional cycles to provide values of entries. In one embodiment, register 130 receives the value for the first entry from input 102 via path 118A, which bypasses memory unit 110. During performance of read operations, output register 130 may then store the second entry from register 350 via path 118C, followed by the third and subsequent entries received from memory unit 110 via path 118B. In the illustrated embodiment, multiplexer 340 is configured to select between paths 118A, 118B and 118C based on a selection signal 342 provided by control unit 140. In some instances, using an additional register in this manner may be advantageous when one or two entries need to be quickly accessible.

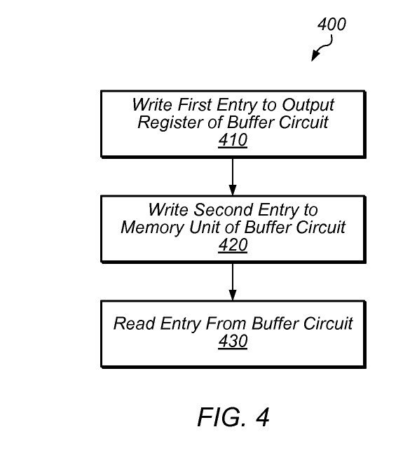

Turning now to FIG. 4, a flow diagram of a method 400 is depicted. Method 400 is one embodiment of a method that may be performed by an integrated circuit that includes a buffer circuit such as buffer 100. In some instances, performance of method 400 may improve buffer access time while also improving power consumption. In some embodiments, step 410-430 may be performed in a different order than shown; in some embodiments, particular ones of steps 410-430 may be performed in conjunction with one another.

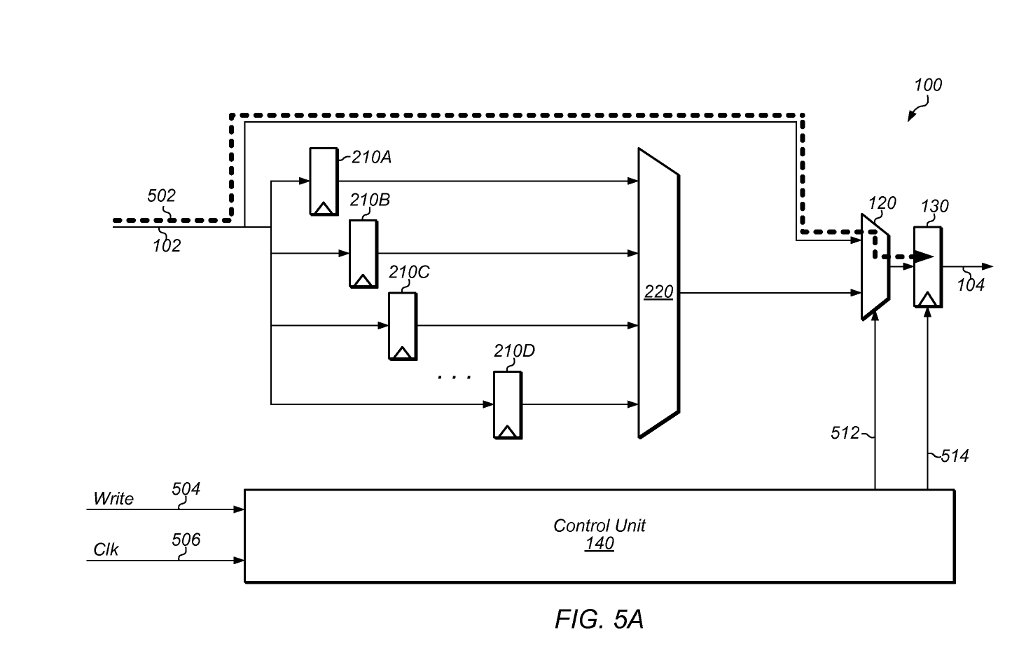

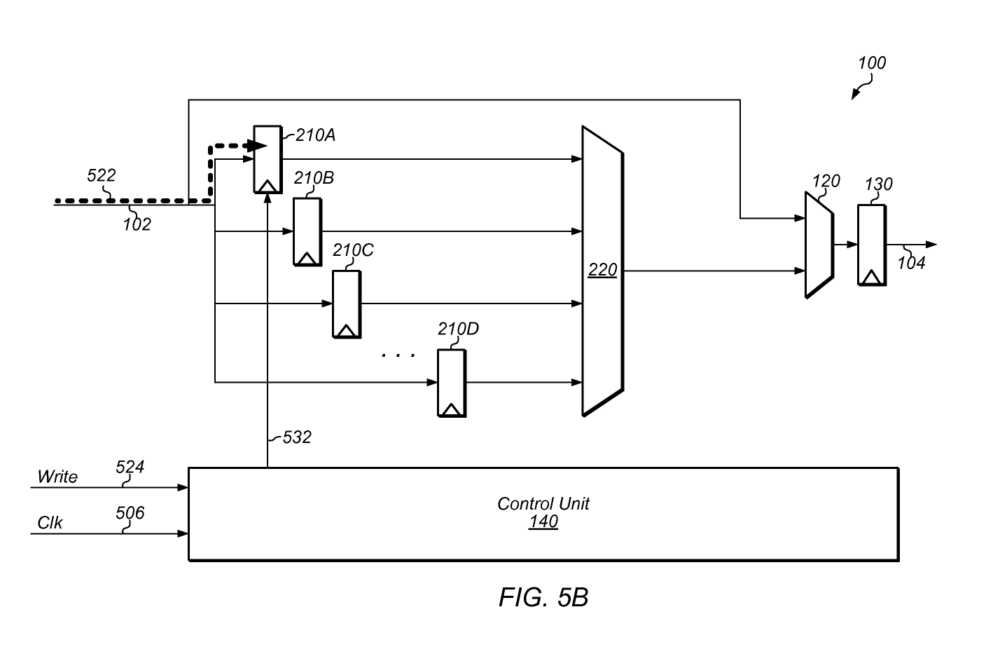

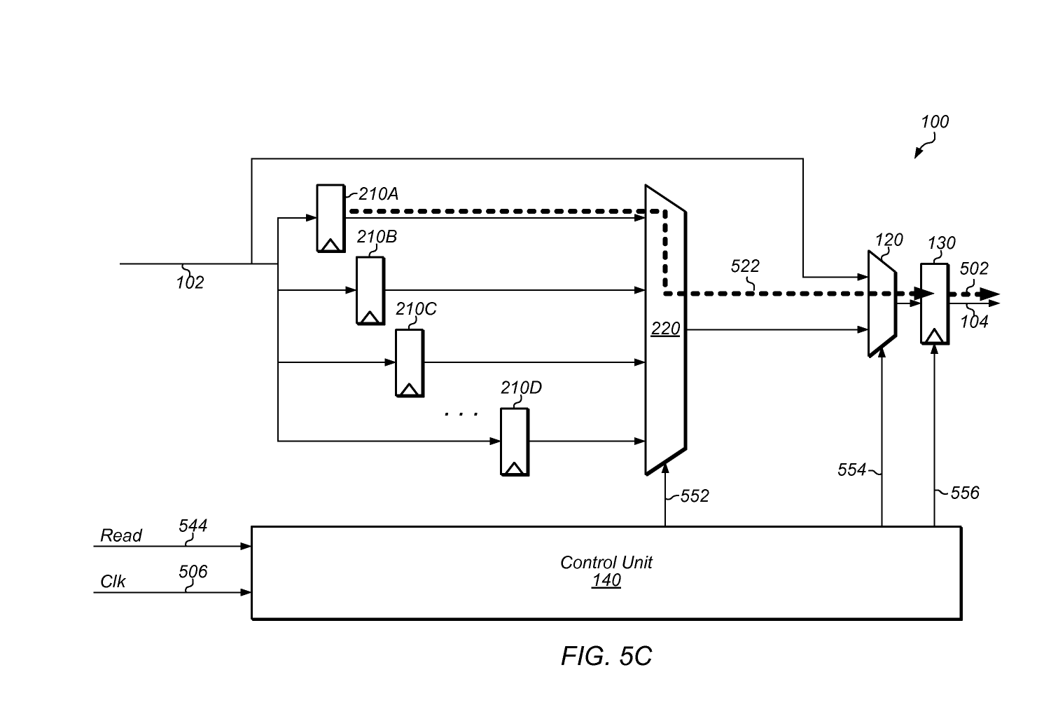

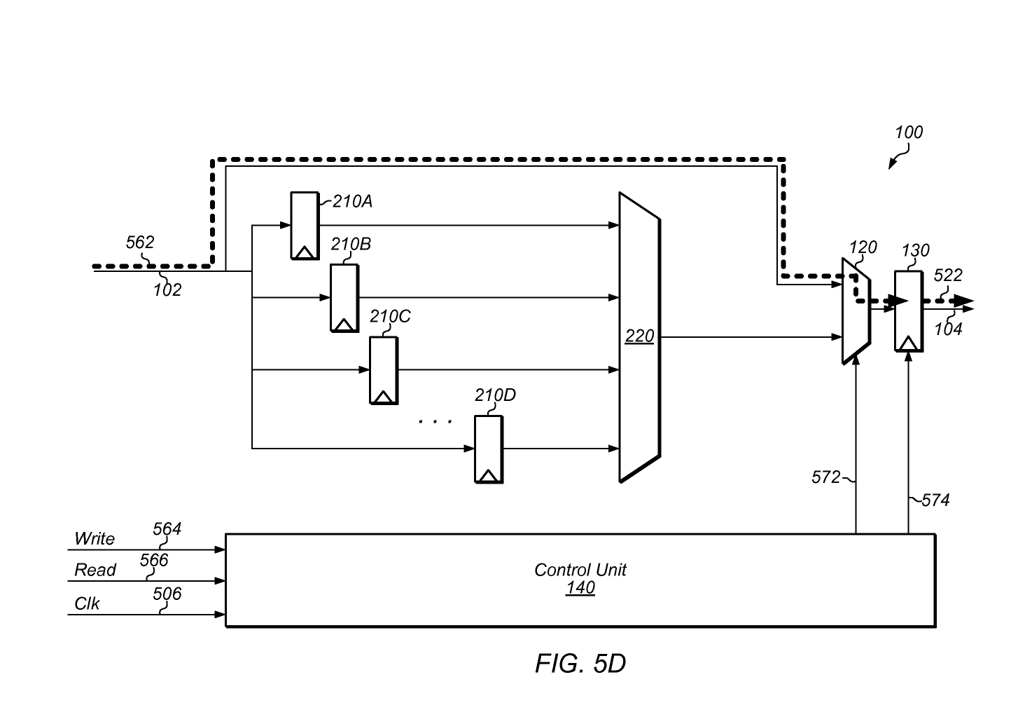

In step 410, a first write operation is performed to write a first value into an output register (e.g., register 130) of a buffer circuit. In one embodiment, step 410 includes bypassing a memory unit (e.g., memory unit 110) of the buffer circuit and storing the first value in the output register of the buffer circuit. In some embodiments, the bypassing includes instructing a multiplexer (e.g., MUX 120) to select a path (e.g., path 118A) that does not pass through the memory unit and conveying the first value along the selected path to the register. An example of one embodiment of step 410 is shown in FIG. 5A discussed below.

In step 420, a second write operation is performed to write a second value into a memory unit of the buffer circuit. In one embodiment, step 420 includes storing the second value to one of a plurality of locations (e.g., associated with registers 210 or memory cells 312) within the memory unit and updating a write pointer (e.g., pointer 112) usable to identify an available location in the memory unit to store a value in a write operation. In some embodiments, the pointer is not updated in response to the initial write operation in step 410. An example of one embodiment of step 420 is shown in FIG. 5B discussed below.

In step 430, a read operation is performed from the buffer circuit. In one embodiment, step 430 includes reading the first value from the output register, storing the second value into the output register, and updating a read pointer (e.g., pointer 114) used to identify a location in the memory unit. An example of step 430 is shown in FIG. 5C discussed below.

Turning now to FIGS. 5A-D, an example of write and read operations performed by one embodiment of data buffer 100 is depicted. In FIG. 5A, an initial write operation is performed for a value 502. As shown, control unit 140 receives a write signal 504 and a clock signal 506. Control unit 140 then provides a selection signal 512 to route the value 502 through multiplexer 120 and provides a latch signal 514 to store the value at register 130. In FIG. 5B, control unit 140 receives a subsequent write signal 524 and provides a latch signal to register 210A to cause it to latch a second value 522. In FIG. 5C, control unit 140 receives a read signal 544, register 130 outputs the value 502, and control unit 140 provides selection signals 552 and 554 to route value 522 to register 130. Control unit 140 finally provides a latch signal 556 to cause register 130 to latch value 522. In FIG. 5D, control unit 140 receives a write signal 564 and a read signal 566 during the same memory access cycle, register 130 then outputs value 522, and control unit 140 routes a value 562 with selection signal 572 and causes register to latch the value 562 with latch signal 574.

### Exemplary Computer System

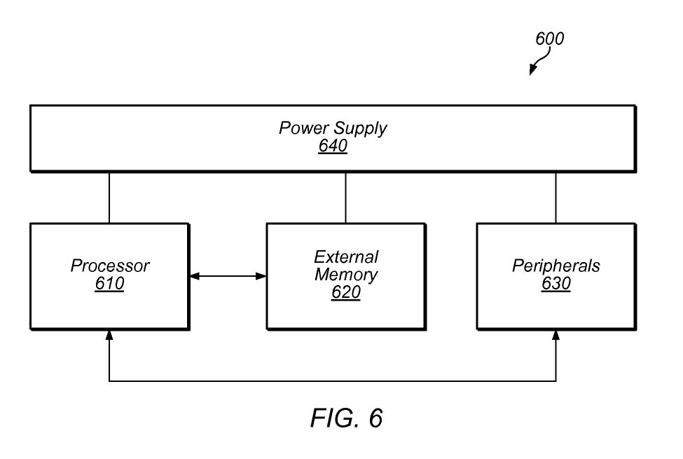

Turning now to FIG. 6, a block diagram of a system 600 is shown. As discussed above, data buffer 100 may be used in a variety of different applications. System 600 is one embodiment of a system that may include one or more buffer circuits such as buffer 100. Accordingly, in some embodiments, one or more instances buffer 100 may be included within processor 610, external memory 620, and/or peripherals 630 described below.

In the illustrated embodiment, processor 610 is coupled to an external memory 620. The external memory 620 may form a main memory subsystem for system 600. Processor 610 is also coupled to one or more peripherals 630. A power supply 640 is also provided which supplies the supply voltages to processor 610 as well as one or more supply voltages to the memory 620 and/or the peripherals 630. In some embodiments, more than one instance of processor 610 may be included (and more than one external memory 620 may be included as well).

The memory 620 may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit that also includes processor 610 in a chip-on-chip configuration, a package-on-package configuration, or a multi-chip module configuration.

The peripherals 630 may include any desired circuitry, depending on the type of system 600. For example, in one embodiment, the system 600 may be a mobile device (e.g. personal digital assistant (PDA), smart phone, etc.) and the peripherals 630 may include devices for various types of wireless communication, such as wifi, Bluetooth, cellular, global positioning system, etc. The peripherals 630 may also include additional storage, including RAM storage, solid state storage, or disk storage. The peripherals 630 may include user interface devices such as a display screen, including touch display screens or multitouch display screens, keyboard or other input devices, microphones, speakers, etc. In other embodiments, the system 600 may be any type of computing system (e.g. desktop personal computer, laptop, workstation, net top etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a buffer circuit that includes:
a memory unit configured to store a plurality of buffer entries, wherein the buffer circuit is configured to store a first pointer to a current one of the plurality of buffer entries; and
an output register coupled to an output of the memory unit;
wherein the buffer circuit is configured to perform a read operation by outputting a current value of the output register and storing a value of the current buffer entry in the output register, and wherein the buffer circuit is configured to update the first pointer in response to the read operation.

2. The apparatus of claim 1, wherein the buffer circuit is configured to perform an initial write operation of a first value, by storing the first value in the output register without initially storing the first value as a buffer entry in the memory unit.

3. The apparatus of claim 2, wherein the buffer circuit is configured to perform a subsequent write operation of a second value, by storing the second value as a buffer entry in the memory unit and updating a second pointer usable to identify an available location within the memory unit to store a value, and wherein the buffer circuit is configured to not update the second pointer in response to the initial write operation.

4. The apparatus of claim 1, wherein the memory unit includes a plurality of registers, each configured to store a respective one of the plurality of buffer entries, and wherein performing the read operation includes:
the buffer circuit selecting one of the plurality of registers based on the first pointer; and
the buffer circuit causing an output of the selected register to be provided to the output register.

5. The apparatus of claim 1, wherein the buffer circuit is configured to implement a first-in-first-out (FIFO) buffer.

6. A method, comprising:
performing a first write operation of a first value to a buffer circuit, wherein the first write operation includes bypassing a memory unit of the buffer circuit and storing the first value to an output register of the buffer circuit; and
performing a second write operation of a second value to the buffer circuit, wherein the second write operation includes storing the second value to one of a plurality of locations within the memory unit and updating a write pointer usable to identify an available location in the memory unit to store a value in a write operation.

7. The method of claim 6, further comprising:
performing a read operation from the buffer circuit, wherein the read operation includes reading the first value from the output register, storing the second value into the output register, and updating a read pointer used to identify a location in the memory unit, wherein the identified location stored the second value.

8. The method of claim 6, further comprising:
simultaneously receiving requests to perform a write operation and a read operation;
in response to the output register storing a value and the memory unit being empty, performing the requested write operation and requested operation by reading a value associated with the requested read operation from the output register during an initial portion of a memory access cycle and storing a value associated with the requested write operation into the output register during a subsequent portion of the memory access cycle.

9. The method of claim 6, wherein the memory unit includes a memory array, and wherein the write pointer is an address of the available location within the memory array.

10. The method of claim 6, further comprising:
the buffer circuit receiving a request to perform a read operation when the buffer circuit is empty; and
the buffer circuit outputting a indication specifying that the buffer circuit is empty.

11. A buffer circuit, comprising:
a memory unit coupled to an input of the buffer circuit via a first path, wherein memory unit is configured to store a plurality of buffer entries, and wherein the buffer circuit is configured to store a pointer to one of the plurality of buffer entries; and
a register coupled to the input of the buffer circuit via a second path that does not include the memory unit, wherein the register is configured to store a single buffer entry of the buffer circuit; and
wherein the buffer circuit is configured to convey a value for a write operation along the first path to the memory unit in response to the buffer circuit storing at least one buffer entry, and to convey the value along the second path to the register in response to the buffer circuit being empty.

12. The buffer circuit of claim 11, wherein an output of the memory unit is coupled to the register via a third path, wherein the buffer circuit further comprises:
a multiplexer coupled to the register, wherein the multiplexer is configured to:
select the second path as an input to the register in response to the buffer circuit being empty during a write operation; and
select the third path as the input to the register in response to the buffer circuit including at least one entry during a read operation.

13. The buffer circuit of claim 11, wherein the memory unit includes a plurality of registers, each coupled to a multiplexer, and wherein the multiplexer is configured to select an output of one of the plurality of registers based on the pointer during a read operation.

14. The buffer circuit of claim 13, wherein the buffer circuit is configured to latch one of the plurality of registers during a write operation based on another pointer usable to identify a register as being available to store a value.

15. The buffer circuit of claim 11, wherein the memory unit includes a two-port memory array with a write port and a read port, wherein the write port is configured to facilitate performances of write operations when the buffer circuit includes at least one buffer entry, and wherein the read port is configured to facilitate performances of read operations when the buffer circuit includes at least two buffer entries.

16. A method, comprising:
a first-in-first-out (FIFO) buffer circuit receiving request to perform a read operation, wherein the buffer circuit includes a circular buffer circuit coupled to a register, wherein the circular buffer circuit is configured to store a plurality of buffer entries, and wherein the register is configured to store a single buffer entry;
the buffer circuit performing the read operation by providing a value of the single buffer entry as an output of the buffer circuit and shifting a value out of the circuit buffer and into the register.

17. The method of claim 16, further comprising:
the buffer circuit receiving request to perform a write operation;
in response to the buffer circuit being empty:
the buffer circuit bypassing the circular buffer circuit; and
the buffer circuit writing a value to the register as the single buffer entry.

18. The method of claim 17, wherein the bypassing includes the buffer circuit instructing a multiplexer to select a path that does not pass through the circular buffer circuit, and the buffer circuit conveying a value of the write operation along the selected path to the register.

19. The method of claim 16, further comprising:
the buffer circuit receiving request to perform a write operation; and
in response to the buffer circuit including at least one buffer entry, the buffer circuit writing a value to the circular buffer circuit, including updating a write pointer of the circuit buffer circuit, wherein the write pointer is not updated during a write operation performed when the buffer circuit is empty.

20. The method of claim 16, further comprising:
the buffer circuit receiving request to perform a read operation when the buffer circuit is empty; and
the buffer circuit outputting a previously output value in response to receiving the request when the buffer circuit is empty.

21. An integrated circuit, comprising:
a first-in-first-out (FIFO) buffer circuit including:
a memory array configured to store values into one of a plurality of memory cells; and
a register coupled to an output of the memory array;
wherein the buffer circuit is configured to store a value into the register in response to the buffer circuit being empty, and to store a value into the memory array in response to the buffer circuit including at least one entry.

22. The integrated circuit of claim 21, where the buffer circuit is configured to perform a read operation that includes outputting a first value from the register, read a second value from the memory array, and storing the second value into the register.

23. The integrated circuit of claim 21, wherein the buffer circuit is configured to:
receive a request to perform a write operation and a request to perform read operation;
in response to the buffer circuit including only one entry:
output a value of the read operation from the register; and
store a value of the write operation in the register without storing the value of the write operation in the memory array.

24. The integrated circuit of claim 21, wherein the buffer circuit is configured to store a first address that is used by the buffer circuit to identify one or more memory cells within the memory array that are available to store a value, and wherein the buffer circuit is configured to store a second address that is used by the buffer circuit to identify one or more memory cells storing a value associated with a next read operation to be performed.

25. The integrated circuit of claim 21, wherein the buffer circuit is configured to convey the value to be stored into the register along a path that does not include the memory array.

26. The integrated circuit of claim 21, wherein the buffer circuit further includes:
an additional register coupled to the register;
wherein the buffer circuit is configured to store a value into the additional register in response to the buffer circuit including a single entry, and to store a value into the memory array in response to the buffer circuit including at least two entries.
